(19) United States
(12) Patent Application Publication
(10) Pub. No.: US 2025/0119402 A1
(43) Pub. Date: Apr. 10, 2025

(54) SYSTEMS AND METHODS FOR INTEGRATION OF A PLURALITY OF COMMUNICATIONS

(71) Applicants: Ryan Cantor, D/FW Airport, TX (US); Michael Greenberg, D/FW Airport, TX (US); William Adams, D/FW Airport, TX (US); John Manaloor, D/FW Airport, TX (US); Ryan Primeaux, D/FW Airport, TX (US)

(72) Inventors: Ryan Cantor, D/FW Airport, TX (US); Michael Greenberg, D/FW Airport, TX (US); William Adams, D/FW Airport, TX (US); John Manaloor, D/FW Airport, TX (US); Ryan Primeaux, D/FW Airport, TX (US)

(21) Appl. No.: 18/906,458

(22) Filed: Oct. 4, 2024

Related U.S. Application Data
(60) Provisional application No. 63/542,798, filed on Oct. 6, 2023.

(51) Int. Cl. H04L 51/56; G06F 40/103

(52) U.S. Cl. CPC H04L 51/56; G06F 40/103

(57) ABSTRACT

The present disclosure includes embodiments of a systems and methods of a community-based project platform for providing a collaborative project platform for projects. The embodiments of the methods may include determining one or more available projects for a first set of one or more users, based on a tag for each of the first set of one or more users and a type of the one or more available projects. In response to the determining of the one or more available projects for the first set of one or more users, the methods may additionally include, displaying the one or more available projects to the first set of one or more users.

### CROSS-REFERENCE

The present application claims benefit of U.S. Provisional Patent Application No. 63/542,798, filed Oct. 6, 2023.

### INCORPORATED BY REFERENCE

The disclosure of U.S. Provisional Patent Application No. 63/542,798, filed Oct. 6, 2023, is incorporated by reference herein for all purposes as if set forth in its entirety.

### TECHNICAL FIELD

The disclosure relates to systems and methods to integrate or unify a plurality of different communication types as part of a unified communications thread received by a user and to systems and methods to generate a platform infrastructure to support an integrated or centralized communications dashboard through which the user can receive and access one or more unified communications threads and respond to one or more recipients.

### BACKGROUND

Typically, users may use a plurality of types of communications for communicating with others for business and social media. For example, a user may have access to or may have one or more electronic mail accounts (in other words, a user may have multiple email accounts, which may be hosted through a variety of different platforms, e.g., Gmail, Outlook mail, etc . . . ), text based messaging (for one or more smart phones, for example), and/or social media accounts, among other types of communications. These accounts or services are typically separate services provided by separate service providers or companies, and generally require users to manage multiple different accounts and/or types of communications. Further, different types of users may have limited access to certain accounts based on the type of channel or communication. For example, a user added to a selected type of channel or communication may have read and write or simply read permissions, thus adding additional complexity to management of multiple accounts.

### SUMMARY

Briefly described, the present disclosure is directed to embodiments of systems and methods to integrate or unify a plurality of different communications for a user and, particularly, of systems and methods to generate a platform infrastructure to support integrated or unified communications each for a plurality of users.

As noted, a user may own a plurality of computing devices. Each of those computing devices may include a plurality of forms or types of communications. For example, a user may have one or more personal computing devices, each of which include accounts for electronic mail (email), text message based accounts, call or voice based accounts, social media accounts, and/or message board accounts. Further, a user may have work or business computing devices, each of which may include similar accounts, but separate from personal accounts. Further still, a user may receive many different types of communications throughout a day from varying sources or communications sources.

In accordance with embodiments of the present disclosure, a unified communications system is provided that, in embodiments, is configured to act as a unified inbox adapted to receive communications (e.g. messages such as emails, text messages, posts to social media, website submissions, chats, group messages, voicemail, calendar appointments/reminders, and/or other communications) that may be of a variety of different types or formats, and/or may be delivered from different sources, and compile such different types, formats, and/or source communications into a unified communication thread to be presented to the user. The unified communication thread further may maintain the look and feel of the original communications included therein.

In embodiments, the unified communication thread can be presented to the user in a customizable display format within which all related communications of the unified communication thread (e.g., emails, texts, media files, social media posts, chats, calendar appointments, etc.), and, in some embodiments, attachments included therewith, will be presented together as a substantially single conversation. In some embodiments, multiple unified communication threads may be linked or collapsed into a single conversation. As a result, a user of the unified communications system unified communications system is enabled to access all incoming and outgoing communications within the unified communication thread, regardless of format, type, or source thereof, and can view and reply to such communications in the same format or type so as to provide a substantially seamless integration/inclusion of a variety of disparate communications into a singularly accessible format. In some embodiments, the display or interface screen(s) presented to a user by the unified communications system can be configured to present to the user a customizable dashboard or interface (e.g. an “inbox”) through which a plurality of distinct unified communication threads can be displayed and accessed, and which in some embodiments, also can provide the user with options for viewing, grouping, and/or storing attachments included or associated with one or more of the communications within the unified communication thread.

In embodiments, the user also can be provided with a plurality of options for filters or selectable attributes from which the user can select a variety of different types, sources and/or formats of communications to be received and included within each of the unified communication threads. In embodiments, the unified communications system can be configured to present a unified inbox or centralized communication platform that can be located along a communications pathway between a user of the unified communications system and one or more third parties in communication with the user. In embodiments, the unified communications system can receive, correlate, and combine a variety of different type, format and/or source communications sent to the user from the one or more third parties. For example, in embodiments, incoming communications from the one or more third parties could include text messages, electronic mail communications, social media posts, posts to electronic message boards, comments posted on a user website, calendar appointments, voicemails, video calls, phone calls, etc., all of which can be combined into a unitary communication thread by the unified communications system and can be presented to the user as a single conversation between the user and the third parties.

In addition, in some embodiments, the unified communications system can incorporate a series of user selectable channels, by which, in embodiments, a user can select which types, formats, and/or sources of communications to include in a unified communication thread. For example, in embodiments, such user selectable channels can include email (including in some embodiments, selecting one or more email accounts to be combined), text messages, social media posts, and/or various other sources or types of communications. In some embodiments the user also can be provided with a series of filters/options to select various attributes of communications through the selected channels coming for use in associating (incoming communications) with a selected unified communications thread; while in other embodiments, the unified communications system can be configured to substantially automatically select various attributes based on certain default or user selected filters, e.g., based on email address, phone number, subject terms, and/or various other identifying attributes.

Further options may include a search or smart search. The search or smart search may enable a user to search all unified communications threads, a sub-set of the unified communications threads, a single unified communications thread, contacts, contact information, and/or files using one or more of names, emails, phone numbers, or any content of any message or communication. The search or smart search result may direct the user to the relevant message or communication or, in another embodiment, the result of such a search or smart search may include a list of relevant messages or communications. Further, a user may label, pin, and/or sticky a message or communication within any unified communications thread. Labels may include identifying text and/or symbols that enable a user to quickly and easily sort, filter, and/or organize messages or communications. In some embodiments, the unified communications system further can include a series of auto-responders, forms, and fields associated with the various user selected channels to help facilitate collapsing and reformatting of incoming messages into the unified message format for associating each incoming communication with a corresponding unified communication thread.

Regardless of the source, format or type of communication, each incoming communication can be received by the unified communications system, and will be converted to a unified message format. In embodiments, the resultant reformatted messages each can be assigned to an associated unified communication thread based upon the inclusion of attributes within the unified message sufficient to enable a correlation between the unified message and one or more related messages of a selected unified communication thread. In embodiments, each of the messages assigned to a unified communication thread can be presented as the next message in the series of messages of the unified communication thread, and, in embodiments, can be presented a format in which the communication was originally received, or can be provided with an indication of the type, format or source of the communication. As a result, in embodiments, each of the incoming and outgoing communications of the unified communication thread can appear as a substantially seamless, single chain of communications between the user and one or more third parties with such communications having a look and feel of the type or format of the initial incoming communication.

In an embodiment, the auto-responder may automatically respond to unknown messages or communications or, in other words, the auto-responder may automatically prompt unknown senders to provide some identification (for example, a name, an email address, and/or other identifying text). The unified communications system may utilize responses to an auto-response to associate a sender with one or more unified communications threads. In an example, a user with a plurality of connected and authenticated services, sources, and/or channels may receive a text message (or, in other examples, other types of messages or communications, such as phone calls and/or messages from social media accounts, message boards, and/or other websites). The text message may simply include the text and a sender's phone number. As such, the unified communications system may, via the auto-responder, send an automatic reply to the sender including a request for the sender's email address and/or other identifying data. Further, the unified communications system may enable configuration of the auto-responder via a user. For example, in embodiments, a user may be enabled or granted permissions to configure an auto-responder to set a time for auto-response, set a selected channel or communication method for an auto-response, and/or set a user approval condition prior to sending an auto-response.

Upon reception of the sender's email and/or other identifying data, the unified communications system may associate the phone number with one or more unified communications threads (based on a name, email, and/or other identifying data associated with each of those one or more unified communications thread). After such an association, the unified communications system may merge the originally unknown messages or communications into the associated one or more unified communications threads. In such an example, the unknown messages or communications are identified and merged into a unified communications thread without user interaction.

As noted, in other examples, rather than a text message, the user may receive a phone call. In such an example, the unified communications system may answer the phone call and, via an automated voice response, request an email and/or other identifying information. In other examples (for example, for messages from social media accounts, such as Facebook or Instagram, and/or other website or application based messaging services, such as WebChat), the unified communications system may utilize cookies and/or other tracking algorithms (and/or in other embodiments, different types of methods, such as requesting identifying information) to associate messages or communications with one or more unified communications threads.

The presentation of the unified communication thread enables the user to receive and view all related communications to and from the third parties without having to access different communications portals or systems. For example, rather than having to respond to emails via a phone one or more email accounts, respond to texts via SMS text (e.g. send a text back through a phone) and/or further separately respond to social media posts via various social media applications such as Facebook or Instagram, etc., the user can search the unified communication thread for and respond back to any communication within the unified communication thread regardless of type, format, or source, to one or more third parties (or add other recipients). In addition, in embodiments, the user is able to switch between different communication types or formats as needed to reply and/or forward communications within the unified communications thread to one or more third parties, with the outgoing communication having substantially the same look and feel and operation as the original communication, e.g., the user can switch between text messages, email, social media, chats, group messaging, etc., as needed, without having to change applications or communication threads, and without a difference in look, feel or operation to the recipients. In some embodiments, the user can further select one or more different formats or types of communication to send a reply or new communication in the conversation.

By way of example, and not limitation, in an embodiment, a user, such as a small business owner, can be in communication with one or more customers regarding products or services to be provided by the user. Currently, customers can communicate with the user, such as by a sending the user a text, sending an email, submitting posts through social media and/or messages such as through Facebook Messenger®, through links on a user's website, which communications generally will come in to the user as different communication threads through different sources that the user would have to separately access. For example, the user would have to separately access emails though an email server versus receiving text messages on their phone, versus having to go to separate sites to access social media posts, etc.

In embodiments, the unified communications system of the present disclosure enables all of such incoming communications to be correlated and compiled into a single unified communication thread to be presented to and accessed by the user via a centralized platform or “inbox,” with the incoming communications of the unified communication thread having substantially the same look, feel and action to how they were sent (e.g., texts can show as texts, while emails appear as emails, etc . . . ) and the user can reply to any message in the unified communication thread with the recipient receiving the reply in the same type or format as their original message (e.g. text, email, posts, etc.), and without the user having to switch between different applications to separately access such different type, format and/or source communications. In addition, in some embodiments, additional recipients can be added to a reply to one or more messages of the unified communication thread and can receive the reply in the same format or through reply the same original source.

Still further, in some embodiments, attachments or files included with any of the incoming communications also can be included within the unified communication thread. In messages of the embodiments, such attachments can be selected and displayed separately by the user for display along with the unified communication thread on the dashboard or interface screen provided to the user. In addition, in embodiments, such attachments further can be collapsed into one or more files into a single library that can be associated with the unified communication thread.

In embodiments, the unified communications system may act as a centralized communications manager located along a communication pathway between the user and one or more parties in contact with the user, e.g., customers, vendors, etc. In embodiments the unified communications system may include a number of graphical user interfaces or web based user interfaces; and in use, in some embodiments, an initialization or account creation interface can be provided, which may include an option for a user to include or connect to as many types of communications or communication accounts or sources. By way of example, in embodiments, a user may enter credentials for each of the types of communications or communication accounts or sources to be combined into unified communication threads by the unified communications system, as well as, in some examples, provide for some form of authentication, e.g., two factor authentication. Two factor authentication may include receiving a communication from one of the types of communications or communication accounts or services including a code. The user may then enter the code to verify that the user is actually the owner of an account corresponding to the type of communication or communication account.

In embodiments, the unified communications system may, after adding any number of types of communications or communication accounts, connect to each type of communication or communication accounts via a corresponding application program interface (API). The unified communications system may scan for messages or communications via the API. For example, the unified communications system s may utilize HTTP or HTTPS requests or gets to a RESTful API to determine whether the user has received any new messages. Other algorithms may be utilized to determine whether a message has been received. For example, in other embodiments, the unified communications system may listen for messages or communications. As messages or communications are transmitted, the unified communications system may detect the messages or communications and format and/or display the message or communication (in one or more unified communications threads) to the user. In another embodiment, messages may be sent to the unified communications system.

In such embodiments, the user may send an initial communication to a person or third party, or a person/third party or a first sender may send an initial communication to the user. The unified communications system can, using such an initial communication, generate a unified communication thread (e.g., based on subject, sender/recipient information, or other attributes); and thereafter, for any communications received in response may determine whether the communication received from that person or sender is associated with and should be added to a particular unified communication thread. Such a determination may occur based on the source of the communication, the API used for such a type of communication, and/or based on the particular person or sender sending the communication. In embodiments, the unified communications system may generate a communication thread corresponding to that particular person or sender. In another embodiment, the unified communications system may generate a prompt suggesting a thread for a particular person or sender or may generate a prompt requesting creation of a thread for that particular person or sender, or, in other embodiments, a thread for a plurality people included on a communication (for example, a unique thread for a plurality of people included on an email).

In an example, a communication with other's copied to the message may be initially stored in a unified communication thread associated with the sender. The unified communications system may be configured to, in such examples, allow the user to generate or create a new unified communication thread based on the sender and/or the others copied to the communication.

Upon determination or reception of a communication corresponding to that particular person or sender, the received communication may be added to the communication thread (or, in some embodiments, a new communication thread created and the communication added thereto). In an embodiment, the unified communications system may enable a user to separate communication threads based on the sender sending the type of communication, another classification of the type of communication (for example, work related communications versus personal communications), and/or the amount of other people or senders included on such communications.

Further, in embodiments, the unified communications system may generate reply boxes for each received types of communications, a reply box for a communication thread, and/or an option to reply to any communication within a communication thread. In response to a user providing or entering a reply, the unified communications system may determine the type of communication being responded to. In embodiments, a communication thread may include a plurality of types of communications. In such embodiments, the unified communications system may determine the type of communication to reply to based on the communication being replied to and/or a type of communication selected by the user (for example, the types displayed as selections in the reply box). In other words, the unified communications system may provide a type of communication to every type of communication corresponding to the particular person.

In an embodiment, a reply box may be generated for a unified communications thread at the last message or communication of the unified communications thread. If a user begins a reply in the reply box, the unified communications system may initially treat such a reply as a reply to the last message or communication type (for example, if the last received message or communication was an email, then the reply may be sent as an email). However, the unified communications system may allow a user to select how to reply to a message. Further, a user may select other messages or communications in a unified communications thread to reply to and, unless otherwise specified, the unified communications system may reply to such a message or communication based on the type of that message or communication.

In addition, according to some aspects, the systems and methods of the present disclosure are designed to allow the user to reply to group of people from one conversation, without triggering other conversations. Thus, if a participant from a group of correspondence thread participants responds to the thread the system can split such an additional conversation into its own thread based on the email that is responding to the conversation. For example, if there are 3 contacts on an email, e.g., the user getting the email, the sender having a first email address email1@email.com and a CC′d participant having a second email address email2@email.com. As long as the user responds to the conversation they can send out an email to both email1 and email2 from email1 thread. If the participant with the second email address email2 decides to interact with the conversation, they can be given a new thread dedicated to the email2@email.com contact.

In some embodiments, the unified communications system further can include a series of auto-responders, forms, and fields associated with the various user selected channels to help facilitate collapsing and reformatting of incoming messages into the unified message format for associating each incoming communication with a corresponding unified communication thread. In an embodiment, an auto-responder may utilize dates and times to trigger a communication send. Further the auto-responder may utilize artificial intelligence or machine learning algorithms to fill the content of such an auto-sent communication. The artificial intelligence or machine algorithms may automatically generate the text for such a communication or, in other embodiments, generate an appointment.

After such a determination of type of reply, the unified communications system may re-format the reply and transmit the reply via a corresponding API.

In another embodiment, the user may still receive the communications from each type of communication or account or source on a corresponding device (for example, a text message may still be received via smart phone). Further, a user's response or reply to a communication may prompt the corresponding type of communication or account or source to also transmit the user's reply to the user's account corresponding to the type of communication. In other words, as an example, if a user sends a reply to a particular person or sender, that particular person may receive the reply and the user's account corresponding to the type of reply may receive the reply as a “sent message.”

In another embodiment, the unified communications system may receive and/or allow for phone calls. In other embodiments, if a user receives a voicemail, the unified communications system may, utilizing natural language processing, convert the voicemail to text. In yet another embodiment, a call received through the unified communications system may be converted to text via natural language processing and/or an artificial intelligence algorithm and the text, as a transcript, may be added to a corresponding thread.

Accordingly, an embodiment of the disclosure is directed to a method for integration of a plurality of different types of communications from a plurality of communication sources. The method may include generating an initialization page on a display. The initialization page may be configured to enable a user to select one or more of the types of communications, one or more of the communication sources, or combinations thereof, for inclusion into one or more unified communication threads. The method may include, in response to selection of the one or more types of communications, one or more communication sources, or combinations thereof by the user, connecting to an application program interface for each of one or more communication sources selected by the user. The method may include, upon reception a communication from the selected one or more communication sources for the user, determining the type of communication received. The method may include converting the communication to a message having a unified message format and assigning the message to a unified communication thread. In an embodiment, the unified format message may include a plurality of attributes selected to enable a correlation between the message and one or more related messages of the unified communication thread for assigning the message to the unified communication thread. The method may also include displaying the unified communication thread the user's display. Each message of the unified communication thread may be presented as part of a unitary conversation, and the user is enabled to access and view each message in the unified communication thread and respond thereto.

In another embodiment, the attributes of each unified format message may include at least two or more of a sender, a message, an attachment, file type, or a communication source. The unified communication thread may include a response section for each corresponding sender. In such embodiments, the method may include, in response to reception of a user response to a unified message of the unified communication thread, determining a communication source of the message and determining whether the user response is of a substantially same type of communication as the unified message. The method may include, if the user response is not of the substantially same type, formatting the user response to correspond to the type of communication of the unified message and transmitting a formatted user response via the application program interface of a corresponding communication source. In another embodiment, the formatted user response may include transmission instructions and sender data. The formatted user response may be transmitted to the corresponding sender and an account corresponding to the user.

In another embodiment, displaying the unified communication thread may comprise arranging the messages of the unified communication thread into a unitary linear conversation. In another embodiment, the method may include, prior to a determination of the type of communication, determining whether the type of communication comprises spam, a malicious or unsafe communication, a blocked sender, or combinations thereof. The method may further include, if the type of communication comprises spam, flagging the communication as spam and deleting the communication. The method may include determining whether all communication from a selected sender comprises spam based on one or more of flagged communications or user input and blocking further communication from the selected sender.

In an embodiment, connecting to the one or more communication sources may utilize an authentication method such as multi or two-factor authentication.

Another embodiment of the disclosure is directed to a system to provide one or more communication types from one or more communication sources as unified messages. The system may include an initialization circuitry. The initialization circuitry may be configured to receive one or more selections of one or more communication sources and prompt authentication of one or more selected communication sources. The system may include a communication circuitry. The communications circuitry may be configured to receive one or more communications from one or more authenticated communication services. The system may include a unified message circuitry. The unified message circuitry may be configured to determine a type for each of the one or more communications. The unified message circuitry may be configured to generate a unified communication thread having a unified message format and corresponding to each sender of each of the one or more communications. The unified message circuitry may be configured to generate a reply option for each thread. The system may include a display circuitry configure. The display circuitry may be configured to generate a thread selection for each thread corresponding to each sender of each of the one or more communications and display each thread selection.

In an embodiment, the display circuitry may be configured to, in response to selection of one thread selection, display a corresponding thread. The communications circuitry may be configured to, in response to a selection of the reply option, format a reply to a corresponding communication, format the reply based on a type of the corresponding communication, and transmit the reply, via application program interface of a corresponding communication source, to a corresponding sender.

The one or more communication sources may include one or more of a text message based cellular application, phone calls, an electronic mailing application, a social media account, an electronic message board, a website comments section, an electronic calendar application, website specific communication platforms, or a virtual meeting application.

In another embodiment, the display circuitry may be configured to, in response to selection of a thread selection, displaying a thread corresponding to the thread selection. The display circuitry may be configured to enable a highlight or sticky option for each message in each thread. The highlight or sticky option may cause a selected message to be displayed at a beginning of a corresponding thread.

Another embodiment of the disclosure is directed to a computing device for compiling messages of different communication types, formats, and/or communication sources into unitary communication threads for presentation in a centralized inbox. The computing device may comprise a processor and a non-transitory computer-readable storage medium storing software instructions that, when executed by the processor, receive one or more user selections of one or more communication types, communication sources, attachment types, or combinations thereof, for messages to be included in each unitary communication thread. The instructions, when executed, may prompt authentication of one or more selected communication sources. The instructions, when executed, may receive one or more communications from one or more authenticated communication sources. The instructions, when executed, may determine a communication type for each of the one or more communications. The instructions, when executed, may generate a unified communication thread corresponding to each sender of each of the one or more messages. The instructions, when executed, may format each one or more communication based on the communication type for each of the one or more messages. The instructions, when executed, may generate a reply option for each thread. The instructions, when executed, may display each thread selection.

In another embodiment, the instructions, when executed, may generate a thread selection for each thread corresponding to each sender of each of the one or more messages.

In another embodiment, authentication may include one or more of two factor authentication, multi factor authentication, or other key or token based authentication.

In yet another embodiment, each thread may include one or more communication types, and wherein the one or more communication types includes one or more of a text message based cellular application, an electronic mailing application, a social media account, an electronic message board, or a website comments section. The instructions, when executed, may, in response to a reply from a user via selection of the reply option for a selected thread, format the reply based on the type of a selected message being replied to and transmit the reply to a selected sender via an application program interface of a selected communication source. The reply may be transmitted to the user via the application program interface of the selected communication source as a sent message. Additional threads may correspond to a plurality of senders.

In an embodiment, the non-transitory computer-readable storage medium further stores software instructions that, when executed by the processor, if the one or more communications include another language, translates each one or more communications based on preselected user language and, in response to a reply to the one or more communications include the another language, translates the reply to the another language. In such embodiments, translations may occur in message transit as a communication is being sent or as a user generates the communication. Further, a user may specify when such a translation may occur. Further still, each translation may be saved, along with the corresponding original communication text.

In yet another embodiment, the non-transitory computer-readable storage medium further stores software instructions that, when executed by the processor, if the one or more communications include an attached file, add the attached file to a separate sortable file space associated with a corresponding unified communication thread. In another embodiment, the unified communication thread may include a linear communication format that is configured to be sortable based on one or more factors, the factors including one or more of date received, attachment included, or communication source.

Additional and/or alternative objects, features and advantages of the present disclosure will become apparent to the skilled artisan from the figures, detailed description, and examples herein. Applicant notes, however, that the figures, detailed description, and examples, while indicating certain embodiments of the instant disclosure, are provided for illustrative purposes only and are not intended to be limiting or to imply a particular limitation. Moreover, certain changes and modifications within the spirit and scope of the disclosed technology will become apparent to those of ordinary in the relevant art from this detailed description.

### BRIEF DESCRIPTION OF DRAWINGS

The disclosed aspects, features and advantages of the disclosure will become better understood with regard to the following descriptions, examples, claims, and accompanying drawings. Applicant notes, however, that the drawings illustrate certain embodiments of the disclosure and should not be considered limiting with regards to the breadth and scope of the disclosure:

FIG. 1 is a block diagram of a unified communications system to integrate a plurality of different types of communications and generate a unified communications system, according to an embodiment of the present disclosure;

FIG. 2 is a block diagrams of a unified communication apparatus to integrate a plurality of different types of communications and generate a unified communications system, according to an embodiment of the present disclosure;

FIG. 3 is a block diagram of a computing device to integrate a plurality of different types of communications and generate a unified communications system, according to an embodiment of the present disclosure;

FIG. 4 is a flowchart of a method to integrate a plurality of different types of communications, according to an embodiment of the present disclosure; and

FIGS. 5A through 5E are representations of a unified communications system, according to an embodiment of the present disclosure.

While the disclosure will be described in connection with the preferred embodiments, it will be understood that it is not intended to limit the disclosure to that embodiment. On the contrary, it is intended to cover all alternatives, modifications, and equivalents, as may be included within the spirit and scope of the disclosure as defined by the appended claims.

### DETAILED DESCRIPTION

So that the manner in which the features and advantages of the embodiments of the systems and methods disclosed herein, as well as others, which will become apparent, may be understood in more detail, a more particular description of embodiments of systems and methods briefly summarized above may be had by reference to the following detailed description of embodiments thereof, in which one or more are further illustrated in the appended drawings, which form a part of this specification. However, it is to be noted that the drawings illustrate only various embodiments of the systems and methods disclosed herein and are therefore not to be considered limiting of the scope of the systems and methods disclosed herein as it may include other effective embodiments as well.

Applicant recognized the problems noted above and herein and conceived and developed embodiments of systems and methods to integrate or unify a plurality of type of communications for a user and, particularly, of systems and methods to generate a platform infrastructure to support integrated and/or unified communications each for a plurality of users.

As noted, a user may own a plurality of computing devices, such as a smart phone, laptop, tablet, wearable, desktop computer, and/or other types of computing devices. Each of those computing devices may include a plurality of forms or types of communications. For example, a user may have one or more personal computing devices, each of which include or are used to host accounts and/or applications for electronic mail (email), text message based accounts, call based accounts, social media accounts, and/or message board accounts. Further, a user may have work or business related computing devices, each of which may include similar accounts, but which are separate from personal accounts (for example, work emails, work texts, and so on).

Thus, the unified communications system may include a number of graphical user interfaces or web based user interfaces. An initialization or account creation interface may include an option for a user to include or select a plurality of types of communications, communication accounts or services, or channels to unify (for example, one or more of email accounts, text based accounts, call or voice based accounts, social media accounts, or message board accounts). The user may enter credentials for each of the types of communications, communication accounts or services, or channels as well as, in some examples, provide two factor authentication. Two factor authentication may include receiving a communication (including, in some embodiments, a code) from one of the types of communications, communication accounts or services, channels. The user may then enter the code to verify that the user is actually the owner of the type of communication, communication account or service, or channels.

In embodiments, the unified communications system may, after adding any number of types of communications, communication accounts or services, or channels, connect to each type of communication or communication accounts via a corresponding application program interface (API). In other embodiments, different types of authentication may be utilized, such as token based authentication. In yet other embodiments, different types of communications may utilize different types of authentication, for example, some communication accounts or sources may simply utilize a user generated password, while others communication accounts or sources may utilize two factor authentication or, as noted, token based authentication. In another embodiment, the unified communications system may already be connected to each of a plurality of communication accounts or sources via an API. Upon selection of a communication account or source by the user, the unified communications system may request authentication of the selected communication account or source via the user and, if authentication is received, begin transmitting communications to and/or from the authenticated communication account or source.

In such embodiments, a particular person or sender may send a communication to the user. The unified communications system may determine the type of communication received from that person or sender. Such a determination may occur based on the source of the communication, the API used for such a type of communication, based on the particular person or sender, and/or based on other data included in the communication (for example, such data indicating the type of communication). The unified communications system may then generate a communication thread corresponding to that particular person or sender. In another embodiment, the unified communications system may generate a prompt suggesting a thread for that particular person or sender or may generate a prompt requesting a thread for that particular person or sender. In other words, while the unified communications system may generate a thread, such a thread may be customizable.

As used herein, a thread or unified communications thread may refer to a collection of messages of different types between a user and one or more other parties, people, and/or senders. For example, a thread may include communications via e-mail, SMS text, and/or via some other type of communication between a user and a single person. In another example, the thread may include communications between a plurality of people. In such an example, a user may receive or initiate a communication with a plurality of people (such communications including, but not limited to, an e-mail with a plurality of people included as receivers or a text message with a group, and/or a group communication via a social media platform or other web-based communication). The thread, in such examples, may be defined based on that plurality of people. In other embodiments, the systems described herein may enable a user to create such a thread and/or create separate threads based on others in such a thread including a plurality of people.

Further, the unified communications system may be configured, as noted, such that the user may create, edit, and/or delete threads at any time. Thus, in some embodiments, a thread may correspond to one sender, while others may correspond to a plurality of senders. Thus, the unified communications system may provide a unified inbox or centralized communication platform that can be located along a communications pathway between a user of the unified communications system and one or more third parties in communication with the user.

Upon determination and/or generation of a communication thread corresponding to that particular person or sender, the received communication may be added to the communication thread (or, in some embodiments, a new communication thread may be created and the communication added thereto). In an embodiment, the unified communications system may enable a user to separate communication threads based on the person sending the type of communication, another classification of the type of communication (for example, work related communications versus personal communications), and/or the amount of other people included on such communications.

Further, the unified communications system may generate reply boxes for each received types of communications, a reply box for a communication thread, and/or an option to reply to any communication within a communication thread. In response to a user providing or entering a reply, the unified communications system may determine the type of communication being responded to. In embodiments, a communication thread may include a plurality of types of communications. In such embodiments, the unified communications system may determine the type of communication to reply to based on the communication being replied to and/or a type of communication selected by the user (for example, the types displayed as selections in the reply box). In other words, the unified communications system may provide a type of communication to every type of communication corresponding to the particular person.

After such a determination, the unified communications system may re-format the response (based on the type of communication being replied to) and transmit the reply via a corresponding API.

In another embodiment, for each account or source utilized by a user, that user may still receive communications from each type of communication on that corresponding type of communication (for example, a text message may still be received via smart phone). Further, a user's response to a message may prompt the corresponding type of communication or account or source to also transmit the user's response to the user's communication account or source corresponding to the type of communication. In other words, as an example, if a user sends a reply to a particular person, that particular person may receive the reply and the user's corresponding account of the reply may receive the reply as a “sent message.” For example, if a user sends a reply to a text message via the unified communications system, then the sender may receive the reply as a text message on a corresponding smart phone, while the user may receive the reply to the text message as a sent message on the user's corresponding smart phone.

Further, the unified communications system may be configured to recognize and remove spam or other unwanted communications. The unified communications system, in an embodiment, may not populate communications deemed to be spam, malicious or unsafe messages or communications, and/or a blocked sender per a communication source and may further recognize such communications not identified by such a communication source.

Thus, a user may manage many accounts or communication sources from a central and unified platform. Such a platform may save a user substantial amounts of time. Further, such a platform may ensure that a user does not miss a particular message in one of the multitudes of communication sources. Further, the unified communications system offers a user flexibility to create threads, sticky important communications, and/or allow a user to respond to any type of message or communication via a unified reply box or option to generate a reply per communication in a communication thread. Such improvements and flexibility solve the problems associated with managing a plurality of existing messaging and/or communications platforms.

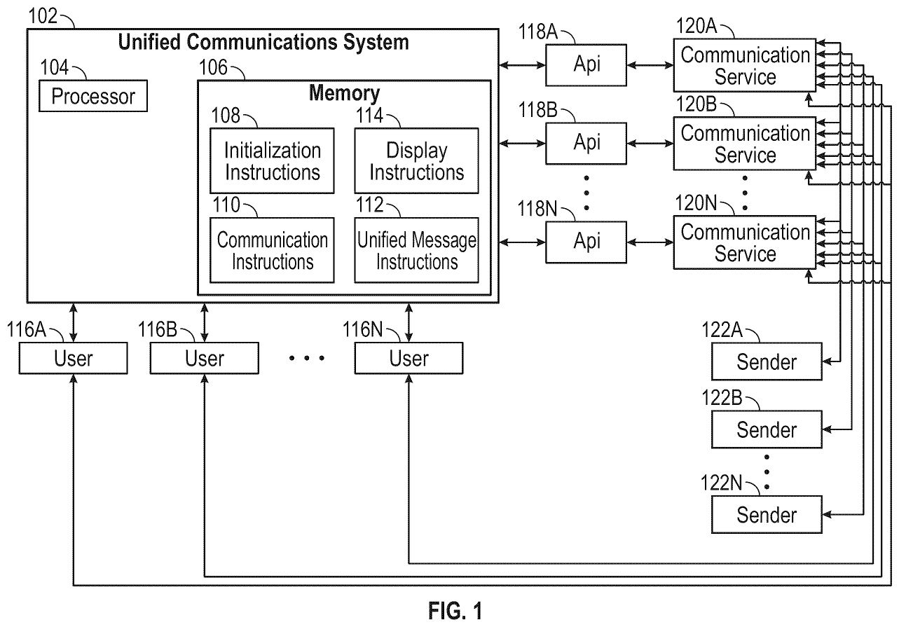

FIG. 1 is a block diagram of a unified communications system 102 to integrate a plurality of different types of communications and generate a unified communications system plurality of unified communication threads that can comprise a single conversation between a user and one or more third parties, which conversation can include most, and in cases, substantially all related communications sent between the user and the third parties, regardless of the type, format and/or source of the communications, according to an embodiment of the present disclosure. The unified communications system 102 may include a processor 104 and memory 106. The memory 106 may store instructions, such as initialization instructions 108, communication instructions 110, unified message instructions 112, and/or display instructions 114. The unified communication system 102 may connect to a number of components and/or devices. For example, the unified communications system 102 may connect to, be configured to connect with, and/or be configured to interface with a plurality of users 116A, 116B, and up to 116N. Any of the plurality of users 116A, 116B, and up to 116N may access the unified communications system 102 via a graphical user interface, web based user interface, and/or via an application or mobile application. As one of the plurality of users 116A, 116B, and up to 116N selects or configures varying options, then the processor 104 may execute various instructions in memory 106. The unified communications system 102 may further connect to one or more communication services 120A, 120B, and up to 120N via corresponding application program interfaces (APIs) 118A, 118B, and up to 118N. Such communication services 120A, 120B, and up to 120N may connect to one or more senders 122A, 122B, and up to 122N (via a similar or the same API). Further, it will be noted that the plurality of users 116A, 116B, and up to 116N may also connect directly to the communication services 120A, 120B, and up to 120N.

As noted, the memory 106 may include instructions. The instructions may include initialization instructions 108. When executed, the initialization instructions 108 may generate a user interface, such as for example, a web based user interface, a graphical user interface, and/or an application interface. The unified communications system 102 may be accessible via an application downloaded onto a computing device, via an executable package residing (in some embodiments, on a user's desktop) on a user's desktop, via a website, and/or as a software as a service website. The initialization instructions 108 may be configured to generate a number of selections for the users 116A, 116B, and 116N corresponding to the plurality of communication services 120A, 120B, and 120N. The initialization instructions 108 may be configured to receive one or more selections of one or more communication services 120A, 120B, and 120N from the users 116A, 116B, and 116N. For example, a user may desire to unify several message based accounts. As the user accesses the unified communications system 102, the user may be presented with various communication service options and/or a search bar (enabling the user to search for particular communication services). Upon selection of any of those communications services, the unified communication system 102 may proceed to configure connection to those selected communications services.

Further, the initialization instructions 108, when executed, may prompt authentication of any selected communication services 120A, 120B, and 120N. The initialization instructions 108 may determine a type of authentication based on the selected communication services 120A, 120B, and 120N. The initialization instructions 108 may prompt the user to authenticate each of the selected communication services 120A, 120B, and 120N based on the type of authentication. Types of authentication may include simple password based authentication, token based authentication, two factor authentication, and/or any other suitable authentication algorithms, as will be understood by a person skilled in the art. The unified communications system 102 may wait until the user has proceeded to provide authentication and, once at least one of the communication services 120A, 120B, and 120N has been authenticated, then the unified communications system 102 may begin receiving messages or communications from that authenticated communications service via the corresponding API for the corresponding user from a plurality of senders 122A, 122B, and 122N.

The memory 106 may include communication instructions 110. The communication instructions 110 may be executed upon reception of a message or communication from a sender 122A, 122B, and 122N. The communication instructions 110 may determine, in response to reception of a message or communication, a type for each of the one or more received messages or communications. The communication instructions 110 may then generate a thread corresponding to a sender for each message or communication received or determine if a thread already exists for the sender. If a thread already exists for the sender, then the communication instructions 110 may add the message or communication to the existing thread. The communication instructions 110 may also generate different types of threads or enable a user to change or customize existing threads.

For example, the communication instructions 110 may generate threads with multiple senders, threads with single senders, and/or threads based on types of communications received. For example, the communication instructions 110 may determine that work based communications should be included in a thread per sender, while personal communication communications may be include in separate threads per senders. In another embodiment, each thread may include duplicate messages in relation to another thread. For example, a thread may include messages or communications from a particular sender, including messages or communications with multiple senders and that particular sender. Other threads for other senders on messages or communications with the multiple senders may include one or more of the same messages or communications. The communication instructions 110 may also facilitate reply's from a user. For example, a user may reply to a particular thread and/or communication within a thread. The communication instructions 110 may determine the type of message that is being replied to, may format the reply based on that determination, and may transmit the reply to the sender in the thread via the API and the communication services. Further, and as noted, the user may be connected to the communications services directly. In such embodiments, as a user generates and sends a reply, the communication instructions 110 may also transmit the reply to an outbox or outgoing communication portion of the communication service corresponding to the user.

The memory 106 may include unified message instructions 112. The unified message instructions 112 may determine the type of each communication. The type of each communication may be based on the communication service associated with the received communication. A communication may include other data and/or metadata. In such an embodiment, the other data and/or metadata may include an indicator corresponding to a communication type. The unified message instructions 112 may also generate the thread (rather than the initialization instructions 108). As noted a thread may be generated based on a number of factors, including, for example, based on the sender, whether the message or communication includes other senders, whether a user has created a selected thread, and/or based on other identifiers (for example, work versus personal messages or communications, messages or communications from a combination of communication services, and/or excluding other communications services).

Once a type of message or communication has been determined, the unified message instructions 112 may format each of the messages or communications based on the determined type of message. The unified message instructions 112 may also generate the thread and a reply option for the thread or for each communication within a thread. For example, the thread may include a serial list of messages from a particular sender or senders. The thread may include an area or portion configured to enable a user to reply to any message within the thread. In another embodiment, such a portion may pop up or pop out, after selecting a “reply” button associated with each communication in a thread.

In an embodiment, the communication instructions 110 and/or the unified message instructions 112 may correlate receive messages to one or more related and/or already received messages. For example, if a user receives a message from a sender from an unknown email address (or other sender identifier from another communication source), the communication instructions 110 and/or the unified message instructions 112 may correlate the unknown email address (or other sender identifier) with a known email address (or other sender identifier) and/or known sender. The communication instructions 110 and/or the unified message instructions 112 may utilize attributes of the received message, such as, for example, data and/or text within the message and/or within attachments in the message, the sender, the email address itself and/or other sender information, file type, the communication source, and/or other data or metadata associated with the message, to perform such a correlation. Once the communication instructions 110 and/or the unified message instructions 112 perform such a correlation, the message may be added to a unified communication thread. In a further embodiment, the unified communications system 102 may prompt a user to verify that the message is placed within the correct unified communication thread and/or may enable the user to select a different unified communication thread.

In an embodiment, in response to a reply from the user, the unified communications system 102 may format the reply, prior to sending, according to the format of the original message or communication that the user is responding to. In such an embodiment, the reply may be formatted such that the sender (or, in other words, the person who sent the original message and is now receiving a reply) may not distinguish between a reply sent via the unified communications system 102 and the communication service or source. The formatted user response or reply may further include transmission instructions (for example, how to format and/or where to send the response or reply) and/or sender data (for example, the sender's email address and/or other identifier, such as a phone number or other identifier associated with another communication source).

In an embodiment, a reply box may be generated for a unified communications thread at the last message or communication of the unified communications thread. If a user begins a reply in the reply box, the unified communications system 102 may initially treat such a reply as a reply to the last message or communication type (for example, if the last received message or communication was an email, then the reply may be sent as an email). However, the unified communications system 102 may allow a user to select how to reply to a message. Further, a user may select other messages or communications in a unified communications thread to reply to and, unless otherwise specified, the unified communications system 102 may reply to such a message or communication based on the type of that message or communication.

In an embodiment, formatting of received communications or messages may include formatting and/or arranging each received message or communication according to a selected format. The selected format may include a linear format or unitary linear format. In other words, each received message or communication, regardless of type of communication, may be ordered sequentially or according to some sorting function selected by the user.

The memory 106 may include display instructions 114. The display instructions 114, when executed, may display each thread as selectable fields in a super-thread display. In other words, a home page or super-thread page may include each of the threads determined by the user and/or unified communications system 102. Each thread may be selectable. Once a thread is selected, the display instructions 114 may change the view to display messages in the selected thread. The messages may be displayed based on the time received. Each thread may further include messages or communications sent. Further, the display instructions 114 may be configured to enable a user to star or highlight a message or communication and/or sticky a message or communication (in other words, stick the message or communication to the top of a thread). In an embodiment, all threads may be searchable. In other words, a user may search for something in every thread at once and/or specifically within each thread.

In another embodiment, the unified communications systems 102 may include instructions to store attached documents in each communication thread. For example, each image, video, audio file, and/or other files may be stored in a separate, sortable space associated with a communication thread. A user can then search for any particular file by name, filter various files by type, and/or download any files via the separate sortable space. Further, the attachments may be displayed in a timeline or chronological based view (in other words, when the attachment was received).

In another embodiment, the unified communications system 102 may include a translator. Such a translator may automatically translate any received message or communications based on a previously selected user language, and in some embodiments, can automatically or selectively translate reply of forwarded messages sent to third parties identified with a particular language. Further, the translated message or communication may include a tag that notes that the message or communication has been translated from a particular language. Further still, response sent to the corresponding sender may automatically be translated based on the sender's message's or communication's language.

By way of example, the unified communications system 102 can incorporate a machine learning model that, upon receiving one or more emails from a specifically identified party in a language, such as German, French, etc . . . , can determine the language used by the sender and apply an indicator of the sender's preferred language next to their name, contact information/card, or other listing to indicate that the sender speaker the identified language. Thereafter, the unified communications system 102 can automatically translate incoming and outgoing messages to match the user and recipient's identified native language, e.g., incoming message to the user can be translated to English, while outgoing messages can be written by the user in English generally automatically translated to German, French, Spanish, or whatever other language is associated/identified with the recipient, and sent any selected format, type, and/or of communication (e.g., Facebook®, email, text, transcribed voicemail, etc.).

In some embodiments, the unified communications system 102 further can include a series of auto-responders, forms, and fields associated with the various user selected channels to help facilitate collapsing and reformatting of incoming messages into the unified message format for associating each incoming communication with a corresponding unified communication thread. In an embodiment, the auto-responder may automatically respond to unknown messages or communications or, in other words, the auto-responder may automatically prompt unknown senders to provide some identification (for example, a name, an email address, and/or other identifying text). The unified communications system 102 may utilize responses to an auto-response to associate a sender with one or more unified communications threads.

In another embodiment, the auto-responder may utilize artificial intelligence or machine learning to perform one or more functions. The auto-responder may use artificial intelligence or machine learning that utilizes natural language processing and/or has been with one or more of a plurality of messages and/or a plurality of messages corresponding to a specific user. In such embodiments, the unified communications system 102 may continuously train such an artificial intelligence or machine learning model with ongoing communications (in other words, the plurality of messages corresponding to a specific user) for each selected user of the unified communications system. Further, in such embodiments, the unified communications system 102 may utilize a specific artificial intelligence or machine learning model for each user. Thus, when a user receives a message in a thread, the auto-responder may provide a response conforming to that user's particular language style (in other words, the language and syntax typically utilized by that user).

Such an auto-responder may automatically generate responses for a user, may generate appointments based on the context of the message received, may prioritize messages, and/or may rank or form a checklist of potential action items. To perform such actions the auto-responder may provide received messages to the artificial intelligence or machine learning model. The artificial intelligence or machine learning model may parse the messages and determine the context and/or other pertinent information based on the application of the messages to the artificial intelligence or machine learning model. Subsequently, the artificial intelligence or machine learning model may then perform a task, such as generating a response, generating an appointment, a checklist, and/or other performing some other task.

As noted, the artificial intelligence or machine learning model may utilize natural language processing and/or other types of models to understand and determine language utilized for a user. As further noted, the artificial intelligence or machine learning model may be continually trained. In such embodiments, a user may provide feedback to the artificial intelligence or machine learning model to improve upon the tasks performed by the artificial intelligence or machine learning model. For example, if the artificial intelligence or machine learning model generates a response to a message, the user may edit the message and provide the edited message to the artificial intelligence or machine learning model as feedback. Further, the unified communications system 102 may generate questions regarding any of the tasks performed by the artificial intelligence or machine learning model for users, which when answered provide feedback for further refinement or training for the artificial intelligence or machine learning model.

In another embodiment, the unified communications system 102 may enable configuration of the auto-responder via a user. Such configurations may include setting a time and/or date for auto-response, setting a specific channel or communication method for an auto-response, and/or setting user approval prior to sending an auto-response.

In an example, a user with a plurality of connected and authenticated services, sources, and/or channels may receive a text message (or, in other examples, other types of messages or communications, such as phone calls and/or messages from social media accounts, message boards, and/or other websites). The text message may simply include the text and a sender's phone number. As such, the unified communications system 102 may, via the auto-responder, send an automatic reply to the sender including a request for the sender's email address and/or other identifying data. Upon reception of the sender's email and/or other identifying data, the unified communications system 102 may associate the phone number with one or more unified communications threads (based on a name, email, and/or other identifying data associated with each of those one or more unified communications thread). After such an association, the unified communications system 102 may merge the originally unknown messages or communications into the associated one or more unified communications threads. In such an example, the unknown messages or communications are identified and merged into a unified communications thread without user interaction.

As noted, in other examples, rather than a text message, the user may receive a phone call. In such an example, the unified communications system 102 may answer the phone call and, via an automated voice response, request an email and/or other identifying information. In other examples (for example, for messages from social media accounts, such as Facebook or Instagram, and/or other website or application based messaging services, such as WeChat), the unified communications system 102 may utilize cookies and/or other tracking algorithms (and/or in other embodiments, different types of methods, such as requesting identifying information) to associate messages or communications with one or more unified communications threads.

In another embodiment, the unified communications system 102 and/or a user may combine two or more unified communications threads. For example, if a user or if the unified communications system 102 combines two or more contacts, the unified communications threads associated with each of the two or more contacts may be combined. The unified communications system 102 may subsequently add new messages to the combined unified communications thread. In such embodiments, the unified communications system 102 may determine which contacts to combine based on information stored for contacts of the user. For example, if a contact card for text messages lists a person name and another contact card for email includes the same or a similar person's name, then the unified communications system 102 may combine threads associated with those contact cards, thus tying those separate threads to one thread.

In yet another embodiment, the unified communications system 102 may be configured to or may include instructions configured to recognize and remove spam or other unwanted communications. The unified communications system 102, in an embodiment, may not populate communications deemed to be spam, malicious or unsafe messages or communications, and/or a blocked sender per a communication source and may further recognize such communications not identified by such a communication source. Such messages or communications may be flagged, by the unified communications system 102 and deleted. The unified communications system 102 may further notify a user regarding deleted messages or communications. In another embodiment, the unified communication system 102 may enable a user to block a sender and/or mark a message as spam. In another embodiment, the unified communications system 102 may determine that a sender comprises a source of spam and/or other unwanted or unsafe messages, based on a selected number (such as, half of the messages, or some larger amount or a preselected threshold number (such as 5, 10, 20, or more), received) of messages or communications from that sender being flagged. Based on such a determination the unified communications system 102 may prevent reception of or delete all messages from such a sender.

In yet another embodiment, the unified communications system 102 may include the option to or enable reminder notifications. For example, the unified communications system 102 may include a setting that enables the user to set a date and/or time for a reminder for a selected unified communication thread. Such a reminder may include a reminder to follow up on a message and/or a reminder to respond to a message. The unified communications system 102 may further enable a user to receive push and/or in-application notifications. For example, when the user selects such a feature, the user's device or devices may each be registered with a unique ID or IDs. Upon reception of a message, the unified communications system 102 may associate the message with the unique ID or IDs and generate and push a notification to the user's device or devices.

In an embodiment, the unified communications system 102 may include a dashboard feature, a user interface, a graphical user interface (GUI), or web-based user interface. The dashboard feature may display the activities or features described herein. For example, if the user or if the unified communications system 102 has set a reminder, then such a reminder may be displayed via the dashboard. Further, an artificial intelligence or machine learning algorithm may be trained to recognize messages or communications that may indicate the need for a response (for example, a message indicating a deadline and/or task) and may automatically generate a reminder to be displayed via the dashboard. In such examples, the artificial intelligence or machine learning algorithm may generate a reminder after a period of time. In the example where the message or communication includes some deadline, then the artificial intelligence or machine learning algorithm may generate such a reminder prior to that deadline. Further, the artificial intelligence or machine learning algorithm may suggest or generate text for a potential response to the message or communication, the text to be displayed in the dashboard and/or in a corresponding communication thread.

Further, the dashboard may include a listing of each of the unified communications threads for a selected user. Other features may be included in the dashboard, such as a help feature, an add contact feature, and/or other features described herein. The dashboard may also display general activity, as noted. For example, the dashboard may include the latest responses generated, the latest messages or communications received, appointments for the current day and/or selected time period, tasks for the day and/or a selected time period, and/or other user activities.

In some examples, the unified communications system 102 may be a computing device. The term “computing device” is used herein to refer to any one or all servers, virtual computing device or environment, desktop computers, personal data assistants (PDAs), laptop computers, tablet computers, smart books, palm-top computers, personal computers, smartphones, virtual computing devices, cloud based computing devices, and similar electronic devices equipped with at least a processor and any other physical components necessarily to perform the various operations described herein. Devices such as smartphones, laptop computers, and tablet computers are generally collectively referred to as mobile devices.

The term “server” or “server device” is used to refer to any computing device capable of functioning as a server, such as a master exchange server, web server, mail server, document server, or any other type of server. A server may be a dedicated computing device or a server module (e.g., an application) hosted by a computing device that causes the computing device to operate as a server. A server module (e.g., server application) may be a full function server module, or a light or secondary server module (e.g., light or secondary server application) that is configured to provide synchronization services among the dynamic databases on computing devices. A light server or secondary server may be a slimmed-down version of server type functionality that can be implemented on a computing device, such as a smart phone, thereby enabling it to function as an Internet server (e.g., an enterprise e-mail server) only to the extent necessary to provide the functionality described herein.

As used herein, a “non-transitory machine-readable storage medium” or “memory” may be any electronic, magnetic, optical, or other physical storage apparatus to contain or store information such as executable instructions, data, and the like. For example, any machine-readable storage medium described herein may be any of random access memory (RAM), volatile memory, non-volatile memory, flash memory, a storage drive (e.g., hard drive), a solid state drive, any type of storage disc, and the like, or a combination thereof. The memory may store or include instructions executable by the processor.

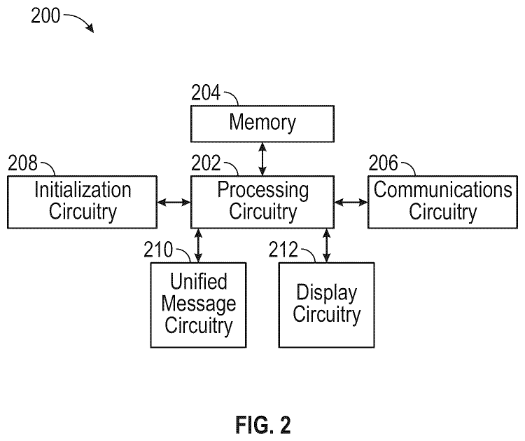

As used herein, a “processor” or “processing circuitry” may include, for example one processor or multiple processors included in a single device or distributed across multiple computing devices. The processor (such as, processor 104 shown in FIG. 1A or processing circuitry 202 shown in FIG. 2) may be at least one of a central processing unit (CPU), a semiconductor-based microprocessor, a graphics processing unit (GPU), a field-programmable gate array (FPGA) to retrieve and execute instructions, a real time processor (RTP), other electronic circuitry suitable for the retrieval and execution instructions stored on a machine-readable storage medium, or a combination thereof.

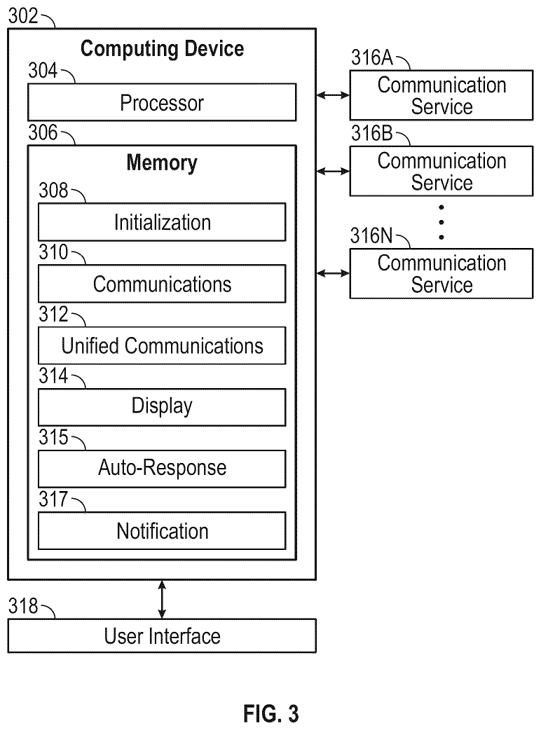

FIG. 2 is a block diagrams of a unified communication apparatus to integrate a plurality of different types of communications and generate a unified communications system, according to an embodiment of the present disclosure. Such an apparatus 200 may be comprised of a processing circuitry 202, a memory 204, a communications circuitry 206, an initialization circuitry 208, a unified message circuitry 210, and a display circuitry 212, each of which will be described in greater detail below. While the various components are illustrated in FIG. 2 as being connected with processing circuitry 202, it will be understood that the apparatus 200 may further comprise a bus (not expressly shown in FIG. 2) for passing information amongst any combination of the various components of the apparatus 200. The apparatus 200 may be configured to execute various operations described herein, such as those described above in connection with FIG. 1 and below in connection with FIGS. 3-5.

The processing circuitry 202 (and/or co-processor or any other processor assisting or otherwise associated with the processor) may be in communication with the memory 204 via a bus for passing information amongst components of the apparatus. The processing circuitry 202 may be embodied in a number of different ways and may, for example, include one or more processing devices configured to perform independently. Furthermore, the processor may include one or more processors configured in tandem via a bus to enable independent execution of software instructions, pipelining, and/or multithreading.

The processing circuitry 202 may be configured to execute software instructions stored in the memory 204 or otherwise accessible to the processing circuitry 202 (e.g., software instructions stored on a separate storage device). In some cases, the processing circuitry 202 may be configured to execute hard-coded functionality. As such, whether configured by hardware or software methods, or by a combination of hardware with software, the processing circuitry 202 represents an entity (for example, physically embodied in circuitry) capable of performing operations according to various embodiments of the present disclosure while configured accordingly. Alternatively, as another example, when the processing circuitry 202 is embodied as an executor of software instructions, the software instructions may specifically configure the processing circuitry 202 to perform the algorithms and/or operations described herein when the software instructions are executed.

Memory 204 is non-transitory and may include, for example, one or more volatile and/or non-volatile memories. In other words, for example, the memory 204 may be an electronic storage device (for example, a computer readable storage medium). The memory 204 may be configured to store information, data, content, applications, software instructions, or the like, for enabling the apparatus 200 to carry out various functions in accordance with example embodiments contemplated herein.

The communications circuitry 206 may be any means such as a device or circuitry embodied in either hardware or a combination of hardware and software that is configured to receive and/or transmit data from/to one or more communication sources (via a corresponding API) network and/or any other device, circuitry, or module in communication with the apparatus 200. In this regard, the communications circuitry 206 may include, for example, a network interface for enabling communications with a wired or wireless communication network. For example, the communications circuitry 206 may include one or more network interface cards, antennas, buses, switches, routers, modems, and supporting hardware and/or software, or any other device suitable for enabling communications via a network. Furthermore, the communications circuitry 206 may include the processing circuitry for causing transmission of such signals to a network or for handling receipt of signals received from a network. The communications circuitry 206, in an embodiment, may enable reception and transmission of messages or communications and may, in some embodiments, format such messages or communications.

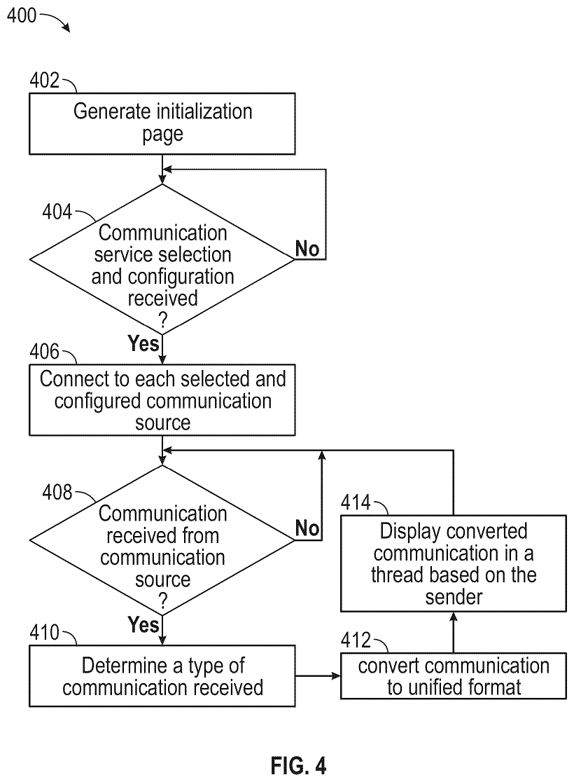

The apparatus 200 may include initialization circuitry 208 configured to enable a user to select one or more communication services, determine an authentication type of selected communication services, configure and/or authenticate each selected communication service, receive communications from the selected communications services, receive replies from a user, determine a corresponding communication service for each reply, and/or transmit the replies to the determined corresponding communication service. The initialization circuitry 208 may utilize processing circuitry 202, memory 204, or any other hardware component included in the apparatus 200 to perform these operations, as described in connection with FIG. 4 below. The initialization circuitry 208 may further utilize communications circuitry 206, as noted above, to gather data (such as received and/or transmitted messages or communications) from a variety of sources (for example, different communication sources). The output of the initialization circuitry 208 may be transmitted to other circuitry of the apparatus 200 (such as the communications circuitry 206 and/or the unified message circuitry 210).

In addition, the apparatus 200 further comprises the unified message circuitry 210 configured to determine a type for each of the one or messages received, generate a thread corresponding to each of the one or more communications, format each of the one or more messages, based on the type for each of the one or more messages, and/or generate a reply option. The unified message circuitry 210 may utilize processing circuitry 202, memory 204, or any other hardware component included in the apparatus 200 to perform these operations, as described in connection with FIG. 4 below. The unified message circuitry 210 may further utilize communications circuitry 206 to gather data (for example, received messages) from a variety of sources (and, in some embodiments, output the baseline three dimensional elevation model. In such examples, the output of the unified message circuitry 210 may be utilized by and/or transmitted to the display circuitry 212.

The apparatus 200 further comprises the display circuitry 212 configured to display a list of communication threads and/or, upon selection of one of the communication threads, messages or communications within the selected communication thread. The display circuitry 212 may utilize processing circuitry 202, memory 204, or any other hardware component included in the apparatus 200 to perform these operations, as described in connection with FIG. 4 below. The display circuitry 212 may further utilize communications circuitry 206 to receive the actual message included in a comminution.

Although components 202-212 are described in part using functional language, it will be understood that the particular implementations necessarily include the use of particular hardware. It should also be understood that certain of these components 202-212 may include similar or common hardware. For example, the initialization circuitry 208, the unified message circuitry 210, and the display circuitry 212 may, in some embodiments, each at times utilize the processing circuitry 202, memory 204, or communications circuitry 206, such that duplicate hardware is not required to facilitate operation of these physical elements of the apparatus 200 (although dedicated hardware elements may be used for any of these components in some embodiments, such as those in which enhanced parallelism may be desired). Use of the terms “circuitry,” with respect to elements of the apparatus therefore shall be interpreted as necessarily including the particular hardware configured to perform the functions associated with the particular element being described. Of course, while the terms “circuitry” should be understood broadly to include hardware, in some embodiments, the terms “circuitry” may in addition refer to software instructions that configure the hardware components of the apparatus 200 to perform the various functions described herein.

Although the communications circuitry 206, the initialization circuitry 208, the unified message circuitry 210, and the display circuitry 212 may utilize processing circuitry 202, memory 204, or communications circuitry 206 as described above, it will be understood that any of these elements of apparatus 200 may include one or more dedicated processors, specially configured field programmable gate arrays (FPGA), or application specific interface circuits (ASIC) to perform its corresponding functions, and may accordingly leverage processing circuitry 202 executing software stored in a memory or memory 204, communications circuitry 206 for enabling any functions not performed by special-purpose hardware elements. In all embodiments, however, it will be understood that the initialization circuitry 208, a unified message circuitry 210, and a display circuitry 212 are implemented via particular machinery designed for performing the functions described herein in connection with such elements of apparatus 200.

In some embodiments, various components of the apparatus 200 may be hosted remotely (e.g., by one or more cloud servers) and thus need not physically reside on the corresponding apparatus 200. Thus, some or all of the functionality described herein may be provided by third party circuitry. For example, a given apparatus 200 may access one or more third party circuitries via any sort of networked connection that facilitates transmission of data and electronic information between the apparatus 200 and the third party circuitries. In turn, that apparatus 200 may be in remote communication with one or more of the other components describe above as comprising the apparatus 200.

As will be appreciated based on this disclosure, example embodiments contemplated herein may be implemented by an apparatus 200 (or by a computing device 302). Furthermore, some example embodiments (such as the embodiments described for FIGS. 1 and 3) may take the form of a computer program product comprising software instructions stored on at least one non-transitory computer-readable storage medium (such as memory 204). Any suitable non-transitory computer-readable storage medium may be utilized in such embodiments, some examples of which are non-transitory hard disks, CD-ROMs, flash memory, optical storage devices, and magnetic storage devices. It should be appreciated, with respect to certain devices embodied by apparatus 200 as described in FIG. 2, that loading the software instructions onto a computing device or apparatus produces a special-purpose machine comprising the means for implementing various functions described herein.

FIG. 3 is a block diagram of a computing device to integrate a plurality of different types of communications and generate a unified communications system, according to an embodiment of the present disclosure. As noted, system 300 may include a computing device 302. The computing device 302 may connect to and/or be in signal communication with communication services 316A, 316B, and up to 316N. Each of the communication services 316A, 316B, and up to 316N may connect to one or more senders and/or one or more users. The computing device 302 may connect to a user interface 318. A user may access the computing device 302 via the user interface 318.

As noted, the memory 306 may store instructions, such as initialization instructions 308. The initialization instructions 308 may be configured to present a selection of one or more communication services 316A, 316B, and up to 316N via the user interface 318 (in some embodiments, in conjunction with display instructions 314). A user may select one or more of the communication services 316A, 316B, and up to 316N via the user interface 318. Upon selection of the one or more of the communication services 316A, 316B, and up to 316N, the initialization instructions 308 may begin authenticating the selected one or more communication services 316A, 316B, and up to 316N. Authentication may include prompting the user to enter credentials, for example, via the user interface 318. Upon entry of credentials, the initialization instructions 308 may further prompt the user to provide another verification (for example, entry of a one-time code, entry of a key phrase, and/or authentication via a token or other security algorithm). After authentication of the selected one or more communication services 316A, 316B, and up to 316N, the computing device 302 may receive and/or transmit communications to and/or from the user interface 318 to a sender connected to the communication services 316A, 316B, and up to 316N.

Memory 306 may store communications instructions 310. The communications instructions 310 may be configured to facilitate communication from/to the user interface 318 to a sender via one or more of the communication services 316A, 316B, and up to 316N. The communications instructions 310 may format received communications according to a unified format. The use of the unified format may ensure that received messages include a similar format regardless of the source (in other words, the communication service providing the communication). The communications instructions 310 may further format transmitted messages to match configurations and/or formatting used by a corresponding communication service.

Memory 306 may store unified communications instructions 312. In an embodiment, rather than then communication instructions formatting the received and/or transmitted communications, the unified communications instructions 312 may format received and/or transmitted communications, as described above. In another embodiment, the unified communications instructions 312 may generate threads and/or add communications to each communication thread. The unified communications instructions 312 may generate a thread based on the sender, user input, and/or based on other factors or identifiers (for example, whether the communication is work related or personal, whether the communication includes a plurality of senders, and/or other factors). In another embodiment, the unified communications instructions 312 may generate a reply option for each communication in each communication thread. For example, the unified communications instructions 312 may position a “reply” button proximate to each communication. In another embodiment, the unified communications instructions 312 may format each communication in a communication thread to be selectable. Once selected, the unified communications instructions 312 may cause a reply section to appear underneath or proximate to the selected communication.

Memory 306 may store display instructions 314. The display instructions 314 may be configured to present each communication thread in a selectable list. Upon selection of a communication thread, the display instructions 314 may cause a selected communication thread to be expanded. In other words, each communication may be displayed for the selected communication thread. Further still, the displayed communication thread may be a scrollable and/or searchable list.

Memory 306 may store auto-response instructions 315. The auto-response instructions 315 may be configured to utilize an artificial intelligence or machine learning model. The artificial intelligence or machine learning model may be trained to produce automatic responses, appointments, appointment fulfillments, and/or automatically attach documents based on application of a message to the artificial intelligence or machine learning model. Any received message for a user may automatically be applied to the artificial intelligence or machine learning model. In another embodiment, prior to application of the message to the artificial intelligence or machine learning model, the computing device 302 may prompt a user to accept the use of the artificial intelligence or machine learning model.

Memory 306 may store notification instructions 317. The notification instructions 317 may be configured to set a date and/or time for a reminder for a selected unified communication thread. Such a reminder may include a reminder to follow up on a message and/or a reminder to respond to a message. The notification instructions 317 may further enable a user to receive push and/or in-application notifications. For example, when the user selects such a feature, the user's device or devices may each be registered with a unique ID or IDs. Upon reception of a message, the notification instructions 317 may associate the message with the unique ID or IDs and generate and push a notification to the user's device or devices.

FIG. 4 is a flowchart of a method to integrate a plurality of different types of communications, according to an embodiment of the present disclosure. Unless otherwise specified, the actions of method 400 may be completed within computing device 302. Specifically, method 400 may be included in one or more programs, protocols, or instructions loaded into the memory of computing device 302 and executed on the processor or one or more processors of the computing device 302. In other embodiments, method 400 may be implemented in or included in components of FIGS. 1-2. The order in which the operations are described is not intended to be construed as a limitation, and any number of the described blocks may be combined in any order and/or in parallel to implement the methods.

At block 402, the computing device 302 may generate an initialization page. The initialization page may include a sign up page, followed by a communication services or sources page. The communication services or sources pages may include one or more supported communication services or sources, such as a plurality of email services, a plurality of text and call based services or sources, social media services or sources, and/or message board services or sources.

At block 404, the computing device 302 may wait for and/or determine if one or more of the communications services or sources to be/are selected. Upon selection of one of the communications services or sources, the computing device 302 may configured and/or authenticate the user in relation to the communication service or sources. Such configuration and/or authentication may include entry of credentials and/or further authentication.

At block 406, after selection and authentication of a communications service or source, the computing device 302 may connect to each selected communication service or source. The computing device 302 may connect to such services or sources via a corresponding API. In such an embodiment, the computing device 302 may send periodic requests to the API (for example, an HTTP get or request to a RESTful API) for new communications. Further, the computing device 302 may transmit replies via the API (for example, an HTTP put to the RESTful API).

At block 408, once the computing device 302 is connected to the communications services or sources, the computing device 302 may begin to scan for communications (for example, as noted above, via HTTP requests to a RESTful API and/or via other scanning and/or data retrieval algorithms). If a communication is received, at block 410, the computing device may determine a type of communication received. For example, the computing device 302 may determine the type of communication based on the communication service or source and/or based on data or metadata included in the communication. At block 412, the computing device 302 may convert the communication to a unified format based on the unified format and the type of communication.

Each communication received may share the same unified format, however, different formatting may occur based on the type of message. For example, a text message typically does not include a subject line. Based on the lack of subject line, the computing device 302 may generate the subject line based on keywords included in the text message. In another example, some emails may include all previous communications, the computing device, in such examples, may remove the previous communications, as those communications are already listed in the communication thread.

At block 414, the computing device 302 may display the converted communication in a thread based on, at least the sender. Other threads may be based on user input and/or the inclusion of a plurality of senders or other user included in the message (in other words, a message with more than two users copied on the communication). After such steps, the computing device 302 may continue to scan for new messages.

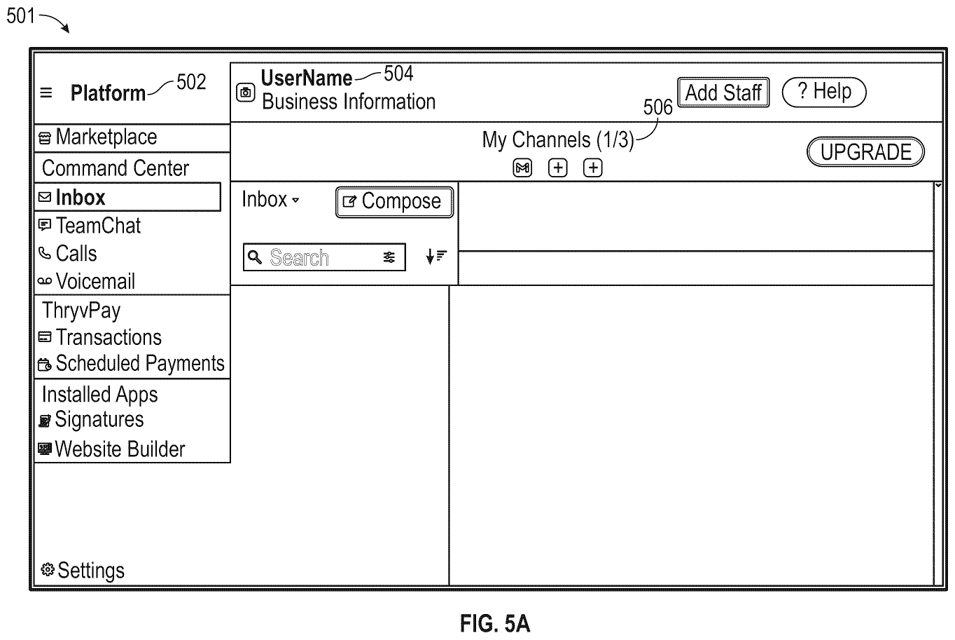

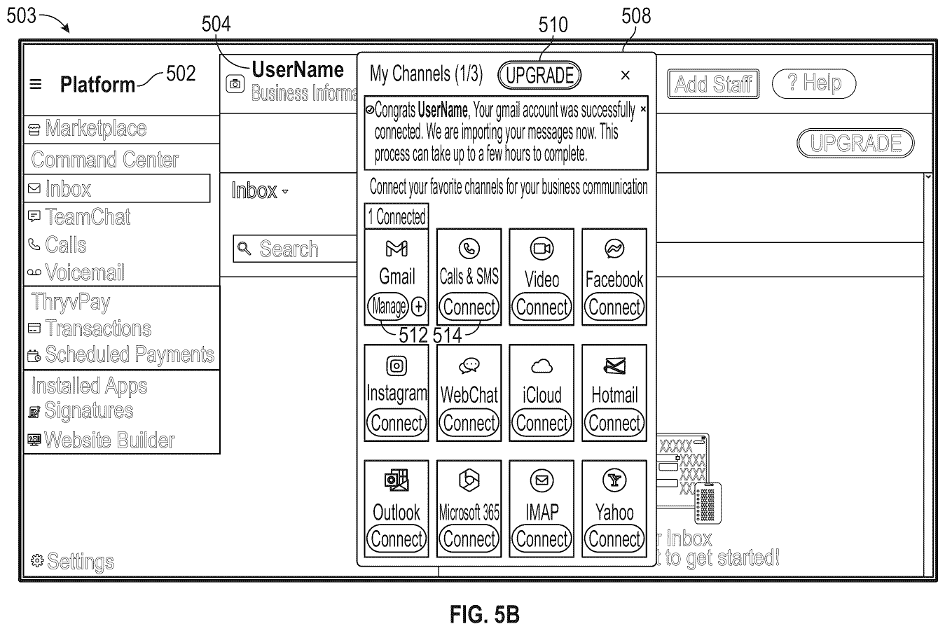

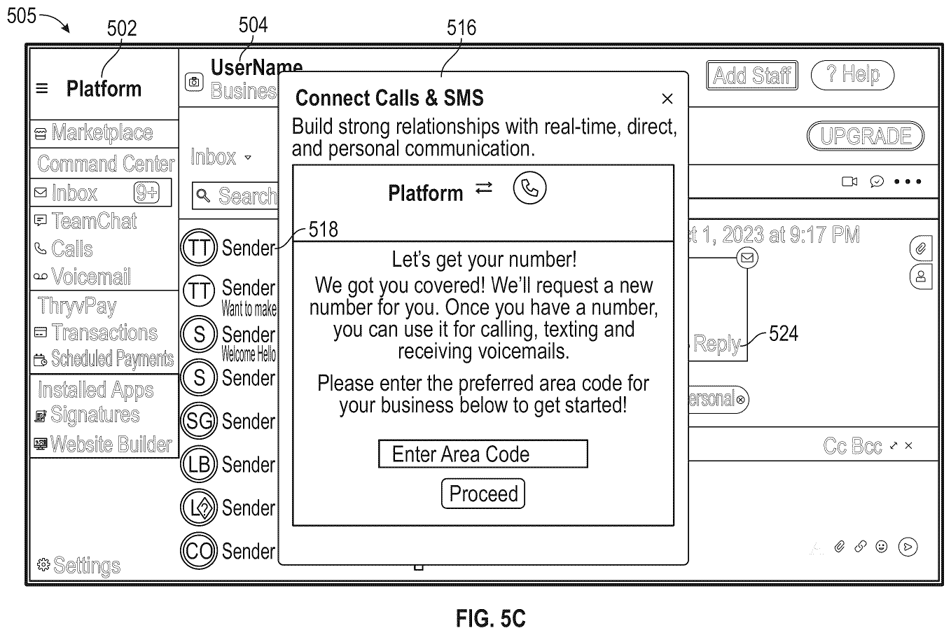

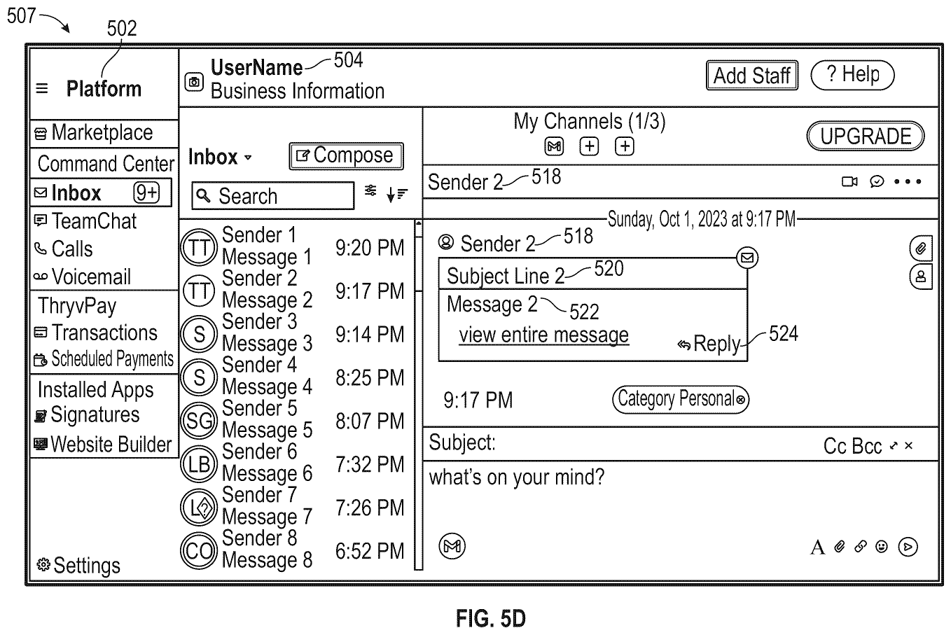

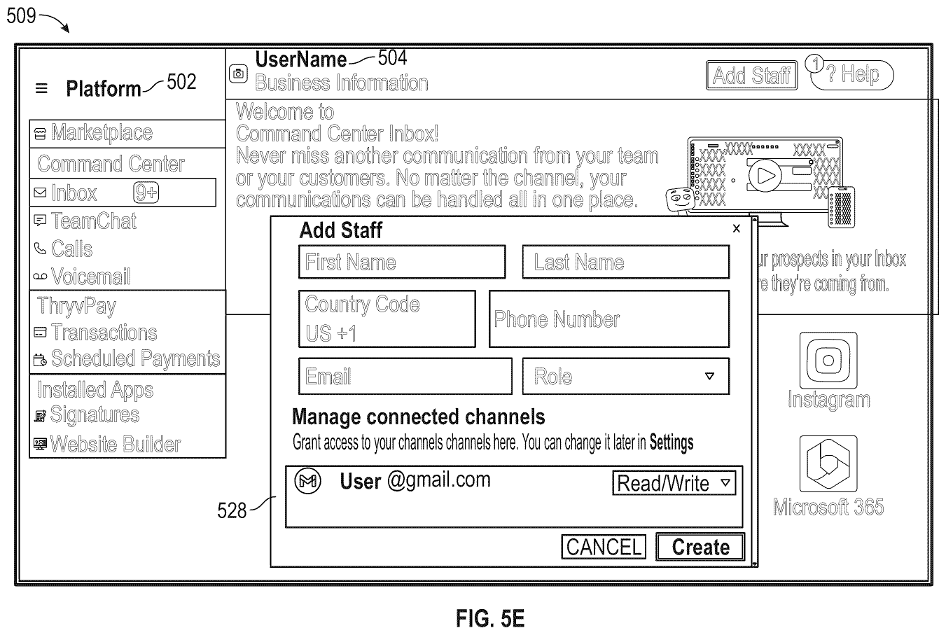

FIGS. 5A through 5E are representations of a unified communications system 502, according to an embodiment of the present disclosure. In an embodiment, the unified communications system 502 may include one or more user interfaces, GUIs, or web-based user interfaces. For example, as illustrated in FIG. 5A, the unified communications system 502 may include a home page 501. Such a home page 501 may include the user's user name 504 and currently connected communication services, sources, and/or channels 506.

Further, a user may add more communication services, sources, and/or channels 506 by selecting the plus button. Upon selection of the plus button, a communication services, sources, and/or channels addition interface 508 may appear (as illustrated in 503) and may list supported communication services, sources, and/or channels, such as Gmail 512, calls and SMS texts 514, video, Facebook, Instagram, WebChat, iCloud, Hotmail, Outlook, Microsoft365, IMAP, and/or Yahoo. Such a list is an example and it will be understood that other services, sources, and/or channels may be included, such as various websites, message boards, and/or other communications sources.

Upon selection of a service, source, or channel, a configuration page 516 may appear, as illustrated in 505 of FIG. 5C. A user may proceed to enter data and/or credentials to configure such a service, source, or channel. Finally, as illustrated at 507 in FIG. 5D, the unified communications system 502 may populate home page with communications threads and communications. A communications thread may be generated based on a sender 518. Upon selection of a communication thread, the page may show messages 522 in that selected thread. Each message may include a subject line 520 and a button 524 enabling a user to reply to the communications. Finally, upon selection of the button 524, the reply fields may be populated.

Turning to FIG. 5E, the image 509 illustrates addition of staff to an account. In an embodiment, upon selection of add staff, the user may be presented with an interface enabling the user to add other users to access their accounts (as shown at 528). Further, the user may select whether the other users have access to read and/or write to one or more services, sources, and/or channels.

Although specific terms are employed herein, the terms are used in a descriptive sense only and not for purposes of limitation. Embodiments of systems and methods have been described in considerable detail with specific reference to the illustrated embodiments. However, it will be apparent that various modifications and changes can be made within the spirit and scope of the embodiments of systems and methods as described in the foregoing specification, and such modifications and changes are to be considered equivalents and part of this disclosure.

What is claimed is:

1. A method for integration of a plurality of types of communications from a plurality of communication sources, the method comprising:
generating an initialization page on a display, wherein the initialization page is configured to enable a user to select two or more of the plurality of types of communications, two or more of the communication sources, or combinations thereof, for inclusion into one or more unified communication threads; and
in response to selection of one or more of the plurality of types of communications, one or more communication sources, or combinations thereof by the user:
connecting to an application program interface for each of one or more communication sources selected by the user, and
upon receiving a communication from the selected one or more communication sources for the user:
determining the type of communication received,
converting the communication to a message having a unified message format and assigning the message to a unified communication thread,
wherein the unified format message includes a plurality of attributes selected to enable a correlation between the message and one or more related messages of the unified communication thread for assigning the message to the unified communication thread, and
displaying the unified communication thread to a user's display, and
wherein each message of the unified communication thread is presented as part of a unitary conversation, and the user is enabled to access and view each message in the unified communication thread and respond thereto.

2. The method of claim 1, wherein the attributes of each unified format message include at least two or more of a sender, a message, an attachment, file type, or a communication source.

3. The method of claim 1, wherein the unified communication thread includes a response section for each corresponding sender, and further comprising:
in response to reception of a user response to a unified message of the unified communication thread:
determining a communication source of the message;
determining whether the user response is of a substantially same type of communication as the unified message, and if not, formatting the user response to correspond to the type of communication of the unified message; and
transmitting a formatted user response via the application program interface of a corresponding communication source.

4. The method of claim 3, wherein the formatted user response includes transmission instructions and sender data.

5. The method of claim 3, wherein the formatted user response is transmitted to the corresponding sender and an account corresponding to the user.

6. The method of claim 1, wherein displaying each of the unified communication threads comprises arranging the messages of each of the unified communication thread into a unitary linear conversation.

7. The method of claim 1, further comprising, prior to a determination of the type of communication determining whether the type of communication comprises spam, a malicious or unsafe communication, a blocked sender, or combinations thereof.

8. The method of claim 7, further comprising, if the type of communication comprises spam:
flagging the communication as spam; and
deleting the communication.

9. The method of claim 8, further comprising:
determining whether all communication from a selected sender comprises spam based on one or more of flagged communications or user input; and
blocking further communication from the selected sender.

10. The method of claim 1, wherein connecting to the one or more communication sources utilizes two-factor authentication.

11. A system to provide one or more communication types from one or more communication sources as unified messages, the system comprising:
an initialization circuitry configured to:
receive one or more selections of one or more communication sources, and
prompt authentication of one or more selected communication sources;
a communication circuitry configured to:
receive one or more communications from one or more authenticated communication services,
a unified message circuitry configured to:
determine a type for each of the one or more communications,
generate a unified communication thread having a unified message format and corresponding to each sender of each of the one or more communications; and
generate a reply option for each thread; and
a display circuitry configured to:
generate a thread selection for each thread corresponding to each sender of each of the one or more communications, and
display each thread selection.

12. The system of claim 11, wherein the display circuitry is further configured to, in response to selection of one thread selection, display a corresponding thread.

13. The system of claim 11, wherein the communications circuitry is further configured to, in response to a selection of the reply option:
format a reply to a corresponding communication;
format the reply based on a type of the corresponding communication; and
transmit the reply, via application program interface of a corresponding communication source, to a corresponding sender.

14. The system of claim 11, wherein the one or more communication sources comprises one or more of a text message based cellular application, an electronic mailing application, a social media account, an electronic message board, a website comments section, an electronic calendar application, or a virtual meeting application.

15. The system of claim 11, wherein the display circuitry is configured to, in response to selection of a thread selection, displaying a thread corresponding to the thread selection.

16. The system of claim 11, wherein the display circuitry is configured to enable a highlight or sticky option for each message in each thread, and wherein the highlight or sticky option causes a selected message to be displayed at a beginning of a corresponding thread.

17. A computing device for compiling messages of different communication types, formats, and/or communication sources into unitary communication threads for presentation in a centralized inbox, the computing device comprising:
a processor and a non-transitory computer-readable storage medium storing software instructions that, when executed by the processor:
receive one or more user selections of one or more communication types, communication sources, attachment types, or combinations thereof, for messages to be included in each unitary communication thread;
prompt authentication of one or more selected communication sources;
receive one or more communications from one or more authenticated communication sources;
determine a communication type for each of the one or more communications;
generate a unified communication thread corresponding to each sender of each of the one or more messages;
format each one or more communication based on the communication type for each of the one or more communications;
generate a reply option for each thread; and
display each thread selection.

18. The computing device of claim 17, wherein the non-transitory computer-readable storage medium further stores software instructions that, when executed by the processor:
generate a thread selection for each thread corresponding to each sender of each of the one or more messages.

19. The computing device of claim 17, wherein authentication includes one or more of two factor authentication, multi factor authentication, or other key or token based authentication.

20. The computing device of claim 17, wherein each thread includes one or more communication types, and wherein the one or more communication types includes one or more of a text message based cellular application, an electronic mailing application, a social media account, an electronic message board, or a website comments section.

21. The computing device of claim 17, wherein the non-transitory computer-readable storage medium further stores software instructions that, when executed by the processor:
in response to a reply from a user via selection of the reply option for a selected thread:
format the reply based on the type of a selected message being replied to; and
transmit the reply to a selected sender via an application program interface of a selected communication source.

22. The computing device of claim 21, wherein the reply is transmitted to the user via the application program interface of the selected communication source as a sent message.

23. The computing device of claim 17, wherein additional threads correspond to a plurality of senders.

24. The computing device of claim 17, wherein the non-transitory computer-readable storage medium further stores software instructions that, when executed by the processor:
if the one or more communications include another language, translates each one or more communications based on preselected user language; and
in response to a reply to the one or more communications include the another language, translates the reply to the another language.

25. The computing device of claim 17, wherein the non-transitory computer-readable storage medium further stores software instructions that, when executed by the processor:
if the one or more communications include an attached file, add the attached file to a separate sortable file space associated with a corresponding unified communication thread.

26. The computing device of claim 17, wherein the unified communication thread includes a linear communication format that is configured to be sortable based on one or more factors, the factors including one or more of date received, attachment included, or communication source.
